(19) United States
(12) Patent Application Publication
(10) Pub. No.: US 2017/0169635 A1
(43) Pub. Date: Jun. 15, 2017

(54) METHOD AND SYSTEM FOR VISITOR ACCESS CONTROL MANAGEMENT

(71) Applicant: Rohit Karlupia, Bangalore (IN)

(72) Inventor: Rohit Karlupia, Bangalore (IN)

(21) Appl. No.: 15/376,523

(22) Filed: Dec. 12, 2016

(30) Foreign Application Priority Data
Dec. 10, 2015 (IN) 6613/CHE/2015

(51) Int. Cl. G07C 9/00; H04W 4/02

(52) U.S. Cl. CPC G07C 9/00015; G07C 9/00103; H04W 4/02

(57) ABSTRACT

A method and system for visitor access control management is disclosed. In one embodiment of the present disclosure, the system comprises a resident user device, a security user device, a visitor user device associated with a visitor and a management server, wherein the management server is configured for generating a token in response to a request received from the resident user device, communicating the token to at least the plurality of security user device and the visitor user device, validating the visitor through the security user device by matching the token communicated to the visitor user device and communicating at least one of an ingress or egress of the visitor to the resident user device.

### TECHNICAL FIELD

The present disclosure relates to the systems and methods for managing visitors in gated communities or any residential or commercial buildings in general and more particularly relates to system(s) and method(s) for visitor access control management.

### BACKGROUND

In the recent years, there has been a significant increase in the number of people living in gated communities or townships. More and more people want to reside in gated residential communities or township because of lot of benefits offered, such as higher standard of home quality, quality infrastructures, privacy, access to shared luxuries such as swimming pools, club houses and fitness facilities, and security. Among various benefits, the number one reason people choose to live in gated communities is likely the safety and security element. Generally, all establishments including residential and commercial gated communities are legally required to maintain a record of all visitors with entry and exit times to safeguard authorized and unauthorized visitors. Even when not legally required, it is important to know who visited the establishment, time of visit, purpose of visit, authorizing person and when did the visitor leave the establishment. In case of any consequences, it should be possible to contact the visitor or authorizing person for questioning if required.

A common method employed by most of the gated communities for dealing with visitor access control is by employing staff members or security persons at controlled access points such as entry and exits gates of the gated community. Typically, when a visitor presents, him or herself for access to visit a particular resident, various types of staff-enforced security checks are implemented starting with recording visitor name, visitor contact details, identity proof of the visitor, resident or contact person name, time of visit, purpose of visit and the like on a paper register. Often the security person may also call the resident who has authorized the visit if intercom is available. However, such method includes various security checks and verification steps for increased security and hence increases the time spent per person at the security check, consequently requires more manpower and prone to human errors.

With the advancement in technology, more sophisticated means for accomplishing various aspects of dealing with the visitors into a gated or business are disclosed. For example, computers are provided to the security persons allowing the security person to make an entry for each visitor including phone numbers and in some cases the phone number is also verified by sending SMS. However, such systems still depend on the visitor to honestly reveal their phone numbers in subsequent visits and the person they intend to meet. Moreover such systems significantly increase the time spent at the gate and also require significant computer skills to operate.

Further means includes providing temporary badges which may be used to track the movement of the visitors at various access points. Time of returning the badge helps in noting down the exit time of the visitors. However, such means again require significant time at the time of issuing the badges. Also requires system to program the badges and installation of various electronic gate systems which operate using the badges, owing to increased installation and maintenance cost. Moreover, the security person needs to call the resident to authorize the visit.

Hence the conventional visitor access control systems have various limitations. The most important limitation is the absence of any check on the phone number provided by the visitors, since such numbers are not verified. The other important distinction is that the authorization of the visitors and authorization of the visit. Identity proofs may be faked and not everyone has enough expertise in identifying genuine from fake proofs. Similarly photo identity even if correct, only establishes that the person is what he claims to be but not the fact that he/she is the person who was authorized to enter the premises. The other problem is the granularity of access check. Most of these systems only work at this level: “Allow access to this person. Take signature and self-claimed phone number”.

### SUMMARY OF THE DISCLOSURE

With reference to the background of the disclosure stated above the conventional visitor access management systems, methods or platforms fail to verify the visitors by authenticating visitor and authorizing person/resident. Further, conventional method requires more manpower, time consuming, increased cost and fail to ensure only authorized visitors to specific residents of the community are allowed access into the gated community.

Hence, there is also a need for a method and system that provides controlled access to a gated community ensuring only authorized visitors to specific residents of the community are allowed access into the gated community.

This summary is provided to introduce a selection of concepts in a simple manner that is further described in the detailed description of the disclosure. This summary is not intended to identify key or essential inventive concepts of the subject matter, nor is it intended to determine the scope of the disclosure.

Embodiments of the present disclosure related to a system and method for visitor access control management, within a gated community. In one embodiment of the present disclosure, the system comprises a resident user device, a security user device, a visitor user device associated with a visitor and a management server, wherein the management server is configured for generating a token in response to a request received from the resident user device, communicating the token to at least the security user device and the visitor user device, validating the visitor through the security user device by matching the token communicated to the visitor user device and communicating at least one of an ingress or egress of the visitor to the resident user device.

Also disclosed a method for visitor access control management, wherein the comprising the steps of, generating a token in response to a request received from a resident user device, communicating the token to at least a security user device and a visitor user device, validating a visitor of the visitor user device through the security user device by matching the token communicated to the visitor user device and communicating at least one of an ingress or egress of the visitor to the resident user device.

To further clarify advantages and features of the present disclosure, a more particular description of the disclosure will be rendered by reference to specific embodiments thereof, which are illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1 illustrates an exemplary representation of a system for visitor access control management in accordance with an embodiment of the present disclosure;

FIG. 2 illustrates an exemplary user interface of the resident application for creating a request in accordance with an embodiment of the present disclosure;

FIG. 3 illustrates an exemplary user interface of the security application for validating a token in accordance with an embodiment of the present disclosure;

FIG. 4 illustrates an exemplary visitor user device displaying a token in accordance with an embodiment of the present disclosure;

FIG. 5 is a block diagram of an exemplary management server in accordance with an embodiment of the present disclosure;

FIG. 6 is a flowchart illustrating the method of visitor access control management in accordance with an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having the benefit of the description herein.

### DETAILED DESCRIPTION OF THE EXEMPLARY EMBODIMENTS

For the purpose of promoting an understanding of the principles of the disclosure, reference will now be made to the embodiments illustrated in the figures and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment”, “in one embodiment”, “in a further embodiment”, “in some embodiments”, “in certain embodiments” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limit the scope of the disclosure.

The present disclosure relates to a system and method for visitor access control management, within a gated community. The term “gated community” as described herein refers to a cluster of houses or a residential community or a township. Even though the system and method of the present disclosure is described referring to gated communities, the system may be implemented in any residential and/or commercial establishments such as residential apartments, technology parks, educational institutions, etc.

In one embodiment of the present disclosure, the system comprises a resident user device, a security user device, a visitor user device associated with a visitor and a management server, wherein the management server is configured for generating a token in response to a request received from the resident user device, communicating the token to at least the plurality of security user device and the visitor user device, validating the visitor through the security user device by matching the token communicated to the visitor user device and communicating at least one of an ingress or egress of the visitor to the resident user device.

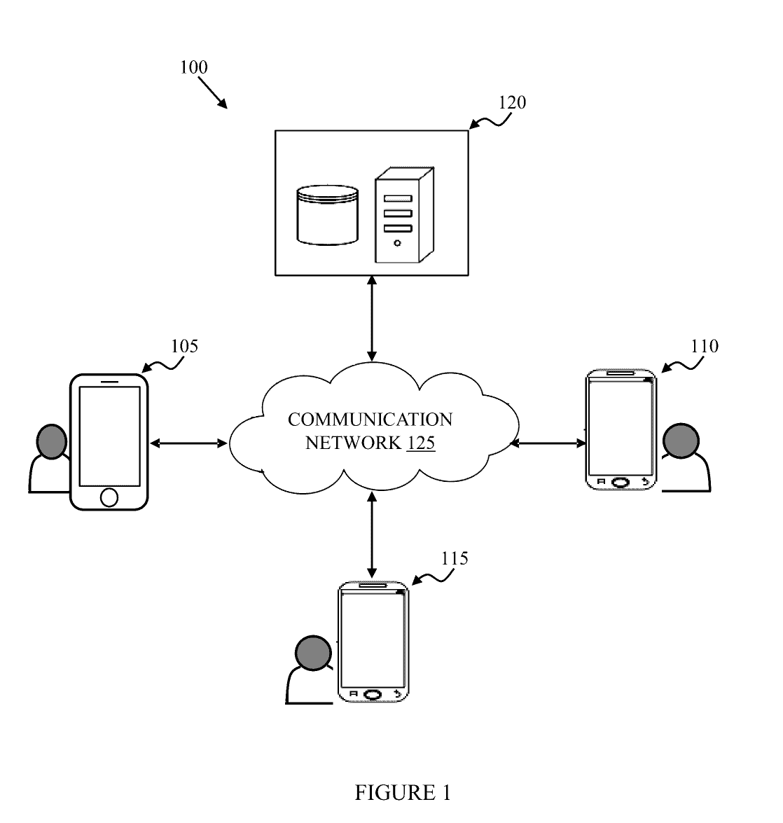

FIG. 1 illustrates an exemplary representation of a system for visitor access control management in accordance with an embodiment of the present disclosure. As shown, the system 100 comprises a resident user device 105, a security user device 110, a visitor user device 115, a management server 120 and a communication network 125. For the sake of simplicity and understanding, one resident user device, one security user device and one visitor user device is shown in FIG. 1. However, the system 100 may include plurality of such devices. For example, in a gated community, each resident may use his/her mobile device (resident user device 105) to communicate with the management server 120. Similarly, each security person is provided with a security user device 110 for communicating with the management server 120.

The resident user device 105, the security user device 110 and the visitor user device 115 may include one of a smartphone, a laptop, a notebook computer, a personal data assistant (PDA) and the like capable of connecting to the internet and having other communication capabilities. However, the visitor user device 115 may be a cellular phone capable of making and receiving audio call and receiving text messages. The resident user device 105 and the security user device 110 may communicate with management server 120 through the communication network 125 in one or more ways such as wired, wireless connections or a combination thereof. It will be appreciated by those skilled in the art that the resident user device 105 and the security user device 110 may include one or more functional elements capable of communicating through the communication network 125 to exchange data with the management server 120.

During operation, a resident who wish to authorize a visitor, generates and sends a request to the management server 120. In one embodiment of the present disclosure, the resident uses his/her smartphone (resident user device 105) to generates the request wherein the request comprises at least one of a visitor name, visitor contact details such as contact number, email ID, date and time of ingress of the visitor, purpose of visit, and the like. Further, the request may comprise visitor address, visitor identity such as unique identifier associated with the visitor, photo, etc. if any. Such request is communicated to the management server 120 through the communication network 125.

The management server 120, on receiving such request, generates a token wherein the token is an alphanumeric string indicative of information pertaining to at least the resident of the resident user device 105 and information pertaining to the visitor. For example, on receiving the request, the management server 120 identifies the resident from a resident database using a unique ID associated with the resident user device 105 and creates a visitor log. The visitor log comprises resident (person who is authorising the visit) information such as name, contact number, flat number, etc. and visitor information such as the visitor name, visitor contact details such as contact number, email ID, date and time of ingress of the visitor, purpose of visit, and the like. Then creates the token for the log which is the alphanumeric string indicative of information pertaining to at least the resident and information pertaining to the visitor. In preferred embodiments of the present disclosure, thus generated token is sent or communicated to the visitor user device 115 through the communication network 125. In some implementations, the token is sent to the visitor user device 115 as a SMS or through a call. In some other implementations, the token is communicated both to the visitor user device 115 and to the plurality of security user devices 110. In one embodiment of the present disclosure, the management server 120 sets validity for the token and the token is valid for a pre-defined time and maps to one unique visit. Hence, such active tokens are unique for the pre-defined time and may be reusable by the system, once the token expires, to keep a bound on the size of the tokens.

In one implementation, the token is communicated to the visitor user device 115 immediately preceding the time of ingress, hence to avoid misuse of token by the visitor. For example, if the visiting time is “4 pm”, then the token is communicated to the visitor user device 115 just before the visit, may be at 3.45 pm. In another implementation, the token is communicated to the visitor user device 115 upon detecting location of the visitor user device 115. For example, the location of the visitor user device 115 is determined using GPS and the token is communicated to the visitor user device 115 when the visitor is in the vicinity of the gated community.

When the visitor visits the establishment/gated community premises, the visitor shares the token with the security person who is using the security user device 110. The security person validates the token by entering the token in the security user device 110. In one embodiment of the present disclosure, the token is validated by the security user device 110, if the token is already received the security user device 110 and time of ingress is recorded in the management server 120 (or log). In preferred embodiments of the present disclosure, the security user device 110 validates the token by making API calls to the management server 120. That is, the security user device 110 communicates the token to the management server 120 for validation. The management server 120 validates the token by comparing with the already generated token, and on successful validation, the ingress time is recorded in the visitor log. Further, the management server 120 communicates the visitor log associated with the token for further verification, if required. That is, if the token is valid, as an additional check, the visitor log is displayed on the visitor user device 115. As described, the visitor log may comprise but not limited to resident (person who is authorising the visit) information such as name, contact number, flat number, etc. and visitor information such as the visitor name, visitor contact details such as contact number, email ID, date and time of ingress of the visitor, purpose of visit, and the like. The security person may confirm visitor information and the resident information as an additional security check.

In one embodiment of the present disclosure, the security user device 110 may be replaced with an IoT based dial pads using which the visitor may validate himself/herself by entering the token. Such devices may be incorporated at the security gates and may use Bluetooth or NFC protocols for reading the token.

In one embodiment of the present disclosure, at the time of visitor leaving gated community premises, the resident may request for an exit token using the resident user device 105. The exit token is generated in a similar way as described above and the communicated to the visitor user device 120 through NFC, Bluetooth or as an SMS as described above. Thus received token is validated at the exit gate by the security person using security user device 110 and the exit time is recorded in the visitor log. In some implementations, single token associated with a visitor may be used for both ingress and egress. In some implementations, if the visitor is visiting multiple residents or apartments, the exit token is not sent immediately. The management server 120 waits for exit token from all the residents (noted in visit token) and then generates a single exit token for the visitor. In one embodiment of the present disclosure, the exit token has a validity to ensure security. For example, the resident may notify the management server 125 that visitor is leaving now by sending a request for exit token. Then the management server 125 generates the exit token and defines validity for the exit token and sends the exit token to the visitor user device 115 and to the one or more security user devices 110 operating at the exit gates. When the exit token is presented to the security user device 110 while leaving, the management server 125 tracks the exit time of the visitor. In one embodiment of the present disclosure, the exit token is not used within the pre-defined time (validity), then the management server 125 sends notification or alerts the one or more security user devices 115. Hence the system 100 alerts security persons in case the visitor left the apartment/person but doesn't come out of the apartment/building within some configurable timeout.

On the other hand, a visitor not having the token may request for a resident for generating a token. For example, a visitor (delivery person) who wish visit multiple apartments in a single visit may send requests to multiple residents for the same visit. Such a request is counted as one visit with one token which tracks all the residents who have authorized the visit. The manner in which the visitor access control system is implemented is described in detail further below.

Referring back to FIG. 1, the communication network 125 may be a wireless network or a wired network or a combination thereof. Wireless network may include long range wireless radio, wireless personal area network (WPAN), wireless local area network (WLAN), mobile data communication such as 3G, 4G or any other similar technologies. The communication network 125 may be implemented as one of the different types of networks, such as intranet, local area network (LAN), wide area network (WAN), the internet, and the like. The communication network 125 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Further the communication network 125 may include a variety of network devices, including routers, bridges, servers, modems, computing devices, storage devices, and the like. In one implementation, the communication network 120 is the internet which enables communication between the resident user device 105, the security user device 110, the visitor user device 115 and the management server 120.

In one embodiment of the present disclosure, the resident user device 105 comprises a resident application (hereafter referred as resident APP) which enables the residents to register with the visitor access control system 100 by providing necessary registration credentials. The registration credentials may include user name (resident), flat number, contact details, and the like. Such credentials are recorded in a resident database associated with the management server 120. In one embodiment of the present disclosure, the resident APP enables the resident to authorize the visitor by generating a request to the management server 120.

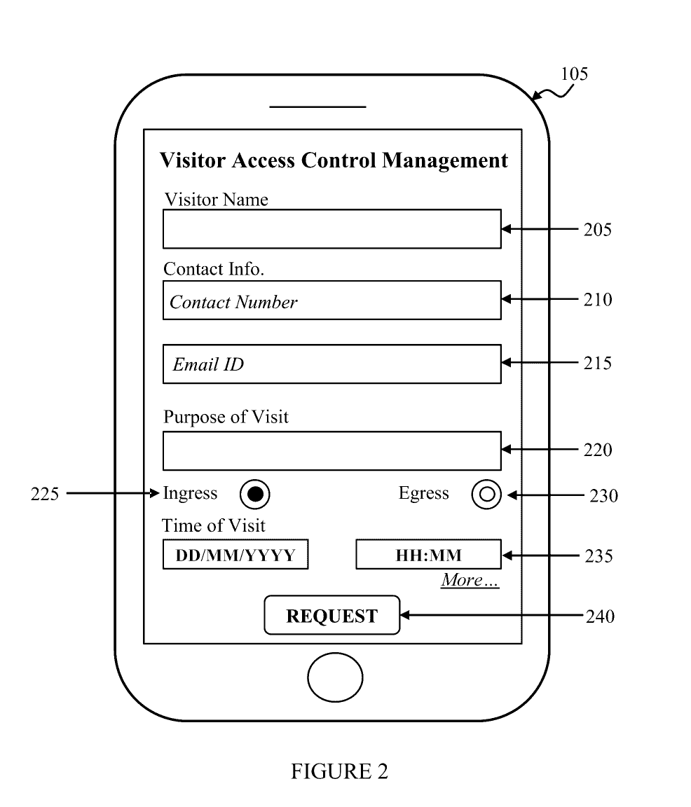

FIG. 2 illustrates an exemplary user interface of the resident application for creating a request in accordance with an embodiment of the present disclosure. Upon launching the resident APP, the resident APP provides a user interface enabling the resident to create a request for authorizing a visitor. As shown, the resident may input basic information such the visitor name 205, contact number 210, email ID 215 and purpose of visit 220 using the text boxes provided for the same. Further, the resident request for ingress or egress event using the radio buttons 225 and 230 respectively. On entering such details, the resident APP prompts the resident to enter the date and time of the visit. In one embodiment of the present disclosure, the resident may provide further details by clicking on “more” option wherein further details may include but not limited to identity associated with the visitor(s), number of visitors, type of visit for example business, personal, delivery, etc. and expected time of egress etc. On entering above said information/details, the resident may click on “request” button 240 to send a request to the management server 120. Such request is communicated to the management server 120 through the communication network 125.

In one embodiment of the present disclosure, the resident may import such details from contact list, email applications, messengers, by scanning a visiting card or from any application having such details. In another embodiment of the present disclosure, the resident may export such details from the text messages received from the visitor. In such a scenario, the resident APP extracts necessary information from the message wherein such information may include visitor name, contact number and purpose of visit.

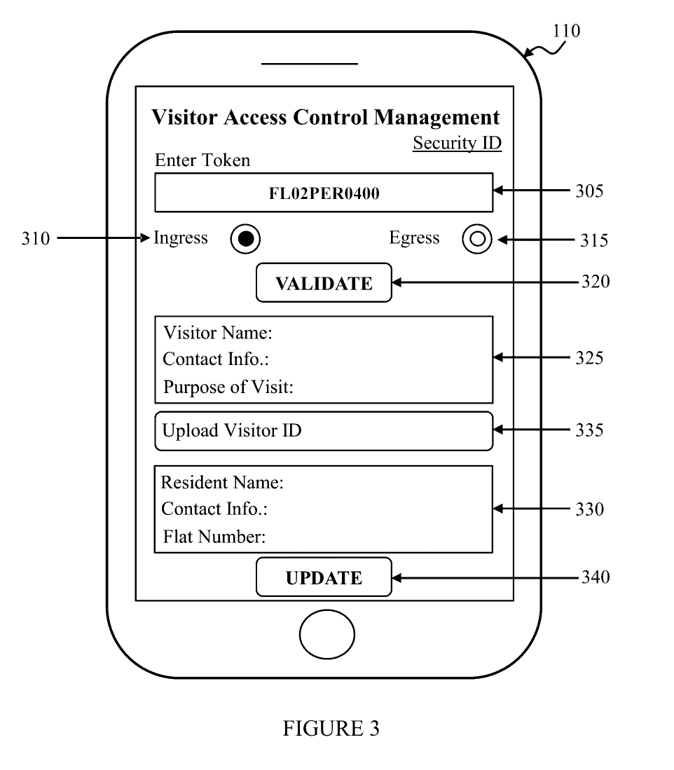

On the other hand, the security user device 110 comprises a security application which enables the security person to validate the token received from the visitor. Each security person is provided with login IDs in order to access the security application. FIG. 3 illustrates an exemplary user interface of the security application for validating a token in accordance with an embodiment of the present disclosure. As shown, the security person may input the token in a text box 305. An example token “FL02PER0400” is an alphanumeric string which maps with the visitor log created in the management server 120. Upon entering the token, the security person may select either “Ingress” or “Egress” using radio buttons 310 and 315 respectively. Then the security person may validate the token by clicking on “validate” button 320 and the security user device 110 communicates the token to the management server 120. On successful validation, the visitor log associated with the token is displayed on the security user device 110 for further verification, if need. As shown, on successful validation, the security application displays visitor information 325 which may include for example, visitor name, contact information, purpose of visit, number of visitors and the like. Further displays resident information 330 which may include resident name, contact information, flat number and the like. In one embodiment of the present disclosure, the security person may further upload visitor identity proof 335 and update the same using “update” button 340 for further verification, if required. Hence, on successful validation, the management server 120 updates the visitor log by recording the time of ingress or egress and security person/device identity used to validate the token. Further, the token is marked as “used” that the token cannot be used again by another person. As described, the security device 110 may be replaced with an IoT based device which enables self-check-in for the visitor thereby eliminates the need of a security person.

In a preferred embodiment, the token is a numeric string to make sure that the security user device or dial pad used to enter the token is small in size and easy to use. Also entering numbers is much simpler on small mobile devices or dial pads. In one embodiment of the present disclosure, the resident may revoke any of the token any time before they are used. Visitor will be notified of any such changes so that they know that the token will no longer be honored. If the token is associated with a multi-resident visit, the token will continue to be valid but the resident who canceled will not be tagged with the visit.

In one embodiment of the present disclosure, the visitor may install a visitor application (hereafter referred as visitor APP) associated with the system in his/her mobile device (visitor user device 115). The visitor APP enables the visitor to request a token from a resident by specifying contact number of the resident. Such a request is sent to the resident user device 105 who may authorize or deny such request. In case the visitor needs to visit multiple apartments in a single visit, the visitor may send requests to multiple residents for the same visit. Such a request is counted as one visit with one token which tracks all the residents who have authorized the visit. Further, the visitor APP provides a way for the visitor to receive tokens using internet. The token sent by the management server 120 is displayed as a notification by the visitor APP. Furthermore, the visitor APP provides a way for sharing the token with the security user device 110 or with the IoT based device via Bluetooth, NFC and other near field communication means. Additionally, the visitor APP enables the visitor to upload photo, identity proof or any identity details to the management server 120. Such information is recorded in the visitor log and made available to the security user device 110 on successful validation for further verification by the security person. As described, a visitor not having the visitor APP may receive the token via a call or through a SMS.

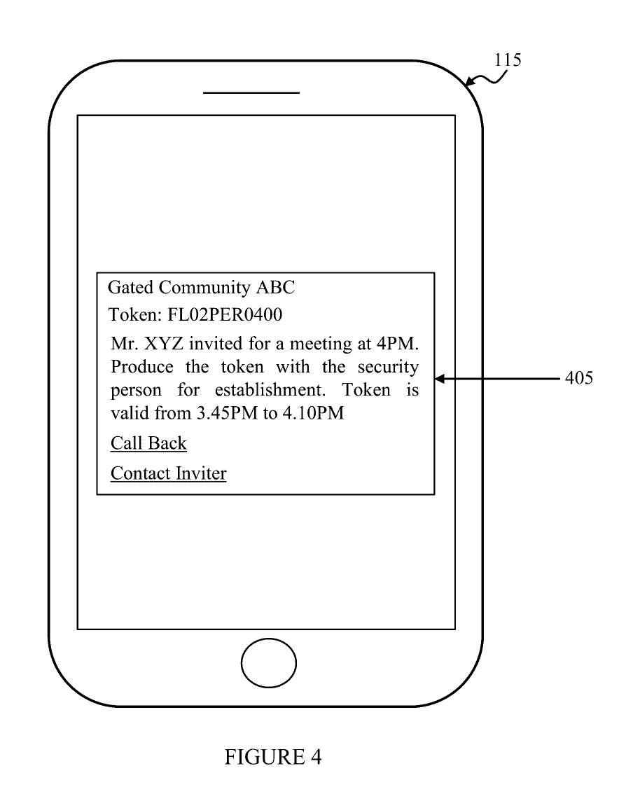

FIG. 4 illustrates an exemplary visitor user device displaying a token in accordance with an embodiment of the present disclosure. As shown, the token is displayed as a message wherein the message may include gated community name, the token, a short message including the inviter name, purpose of visit, date and time and the like. In some implementations, the message may include validity of the token. However, such message may be configured by an administrator of the management server 120.

Referring back to FIG. 1, the management server 120 may include, for example, a computer server or a network of computers or a virtual server which provides functionalities or services for other programs or devices such as for the resident user device 105, the security user device 110 and the visitor user device 115. In one implementation, the management server 120 is a server comprising one or more processors, associated processing modules, interfaces and storage devices communicatively interconnected to one another through one or more communication means for communicating information. The storage devices within the management server 120 may include volatile and non-volatile memory devices for storing information and instructions to be executed by the one or more processors and for storing temporary variables or other intermediate information during processing.

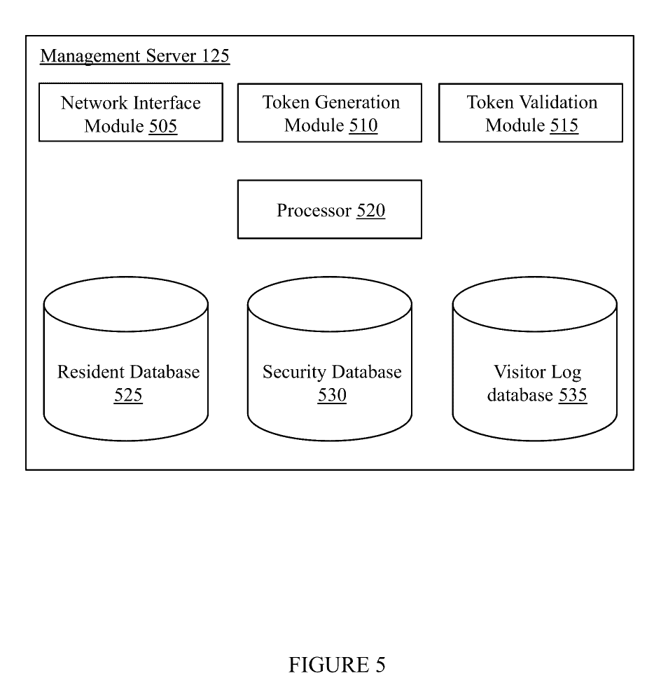

FIG. 5 is a block diagram of an exemplary management server in accordance with an embodiment of the present disclosure. As shown, the management server comprises a network interface module 505, a token generation module 510, a token validation module 515, a processor 520, a resident database 525, a security database 530 and a visitor log database 535. The network interface module 505 connects the resident user devices, security user devices and visitor user devices thereby enables the residents, security persons and visitors to communicate with the management server 120.

The resident database 525 stores records/information pertaining to all the registered residents of the gated community. The resident information may include resident name, contact number, email ID, flat number, resident user device identifier and the like. On the other hand, the security database 530 stores security user device identifier, security person details, login IDs and password associated with the security persons, and the like.

The token generation module 510 generates the token in response to a request received from the resident user device 105. On receiving the request, the token generation module 510 fetches resident information from the resident database 525 and creates a visitor log which comprises the resident information and the visitor information including date and time of ingress or egress, purpose of visit and the like. Further, the token generation module 510 generates a unique token for the visitor log, i.e., for that particular visit. Such visitor log is recorded in the visitor log database 535. Thus generated token is communicated to at least the security user device 110 and the visitor user device 115 through the network interface module 505. In some implementations, the token generation module 510 generates unique tokens per apartment. As described, the token are communicated immediately preceding the time of ingress or egress of the visitor or upon detecting location of the visitor user device 115.

On the other hand, the token validation module 515 is configured for validating the token received by the security user device 110. On receiving the token from the security user device 110, the token validation module 515 compares the token with the one or more generated tokens. If there is a match, then the token is further validated to ensure the token and active. On successful validation, the token validation module 515 marks the token as used and records the time, security person information, the security user device information in the visitor log. Further, the token validation module 515 communicates the visitor log to the security user device 110 for further verification by the security person. In one embodiment of the present disclosure, a notification is sent to the resident user device 105 indicative of successful validation and establishment. If validation fails due to invalid token or expired token, a notification is sent to at least one of the resident user device 105, the security user device 110 and to the visitor user device 115. In some implementations, the token generation module 510 and the token validation module 515 may be implemented on the processor 520.

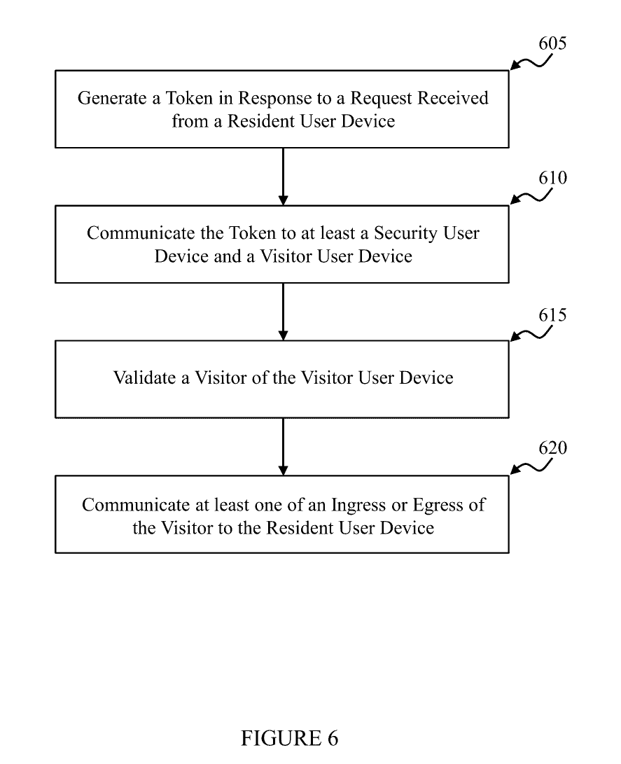

FIG. 6 is a flowchart illustrating the method of visitor access control management in accordance with an embodiment of the present disclosure. At step 605, the management server 120 generates a token in response to a request received from a resident user device 105. The token generation step creates a visitor log and records the expected visitor's information and the resident information authorizing the visit and the time during which such a visit should take place.

At step 610, the management server 120 communicates the token to at least a security user device 110 and a visitor user device 115. In a preferred embodiment, the management server 120 communicates the token to visitor user device 115 immediately preceding the time of ingress or egress of the visitor. Hence when the visitor visiting the establishment, the visitor discloses the token to the security person or IoT based device such as a dial-pad.

At step 615, the management server 120 validates the visitor of the visitor user device 115. In preferred embodiments, management server 120 validates the visitor by comparing the token provided by the visitor with the one or more tokens generated by the management server 120. On successful validation, the management server 120 updates the time of visit and the visitor log is communicated to the security user device 110 for further verification by the security person.

At step 620, the management server 120 communicates at least one of an ingress or egress of the visitor to the resident user device 105. That is, on successful validation, the presence of the visitor is informed to the resident. The successful use of the token validates that the person who is present is a valid visitor and also tracks the time of entry. In a similar way, an exit token is generated and exit time is recorded in the visitor log.

As described, the visitor may request multiple residents to generate tokens for a single visit using the visitor application. When all the residents send requests to the management server for generating tokens, such requests is counted as one request for one visit and a single token generated and communicated to the visitor user device wherein the single token tracks all the residents who have authorized the visit.

In one embodiment of the present disclosure, the system 100 may be implemented for multi-level security. For example in case of large business park/zone, one token may be used for entry at the main gate (first gate), then the visitor log is updated and the same token may be used at the security gate (second gate) of specific building in the business park/zone.

Hence, the method and system for visitor access control management disclosed in the present disclosure replaces the paper register with a management server for recording the visits. Further, the successful use of token validates that the person who is present is a valid visitor and also tracks the time of entry and/or exit. Furthermore, the system maintains records of residents, security staff and visitors and hence ensures complete security. The system 100 makes a record of the token along with the resident, the visitor and the security person or security user device used to validate the token and the time. Further, the system and method eliminates the need of manpower associated with the security management, reduces the cost and time associated with the same.

Even though the system and method for visitor access control management is described referring to gated community, the method and system may be implemented in any commercial or non-commercial establishments to ensure proper security.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A visitor access control management system, the system comprising:
a resident user device;
a security user device;
a visitor user device associated with a visitor; and
a management server, wherein the management server is configured for:
generating a token in response to a request received from the resident user device;
communicating the token to at least the security user device and the visitor user device;
validating the visitor through the security user device by matching the token communicated to the visitor user device;
communicating at least one of an ingress or egress of the visitor to the resident user device.

2. The system as claimed in claim 1, wherein the request received from the resident user device comprises at least one of a visitor name, visitor contact details, time of ingress or egress of the visitor, purpose of visit and the like.

3. The system as claimed in claim 1, wherein the management server is configured for communicating the token to the visitor user device immediately preceding the time of ingress or egress of the visitor.

4. The system as claimed in claim 1, wherein the management server is configured for communicating the token to the visitor user device upon detecting location of the visitor user device.

5. The system as claimed in claim 1, wherein the token is an alphanumeric string indicative of information pertaining to at least the resident of the resident user device.

6. The system as claimed in claim 5, wherein the alphanumeric string is indicative of information pertaining to the visitor.

7. The system as claimed in claim 1, wherein the token is valid for a pre-defined time.

8. The system as claimed in claim 1, wherein the management server is configured for communicating the least one of the ingress or egress of the visitor to the resident user device on successful validation of the visitor.

9. A method for visitor access control management, the method comprising:
generating a token in response to a request received from a resident user device;
communicating the token to at least a security user device and a visitor user device;
validating a visitor of the visitor user device through the security user device by matching the token communicated to the visitor user device; and
communicating at least one of an ingress or egress of the visitor to the resident user device.

10. The method as claimed in claim 9, wherein the request received from the resident user device comprises at least one of a visitor name, visitor contact details, time of ingress or egress of the visitor, purpose of visit and the like.

11. The method as claimed in claim 9, wherein the token is communicated to the visitor user device immediately preceding the time of ingress or egress.

12. The method as claimed in claim 9, wherein the token is communicated to the visitor user device upon detecting location of the visitor user device.

13. The method as claimed in claim 9, wherein the token is an alphanumeric string indicative of information pertaining to at least the resident of the resident user device.

14. The method as claimed in claim 13, wherein the alphanumeric string is indicative of information pertaining to the visitor.

15. The method as claimed in claim 9, wherein the token is valid for a pre-defined time.

16. The method as claimed in claim 9, wherein the least one of the ingress or egress of the visitor is communicated to the resident user device on successful validation of the visitor.
